(19) United States
(12) Patent Application Publication
(10) Pub. No.: US 2002/0140319 A1
(43) Pub. Date: Oct. 3, 2002

(54) Ultrasonic motor

(76) Inventors: Yukihiro Matsushita, Hamakita-shi (JP); Motoyasu Yano, Kosai-shi (JP); Masashi Ishikawa, Hamamatsu-shi (JP)

Correspondence Address: SAWYER LAW GROUP LLP, P.O. Box 51418, Palo Alto, CA, 94303, US

(21) Appl. No.: 10/113,473

(22) Filed: Mar. 29, 2002

(30) Foreign Application Priority Data
Apr. 2, 2001 (JP) 2001-103278

(51) Int. Cl. H02N 2/00

(52) U.S. Cl. 310/323.12

(57) ABSTRACT

A stator of an ultrasonic motor includes a piezoelectric element, a plurality of metal blocks, and a fastener. The piezoelectric element is held by the metal blocks The fastener extends through the piezoelectric element and the metal blocks to fasten the piezoelectric element and the metal blocks together. A rotor is pressed against one side of the stator in a contact state. The rotor is rotated in a first direction by generating oscillation at a first resonance frequency in the stator. Further, the rotor is rotated in a second direction opposed to the first direction by generating oscillation at a second resonance frequency, which corresponds to the resonance frequency of the rotor, in the stator. The outer diameter of the fastener is within the range of from 30% to 55% of the outer diameter of the stator.

### BACKGROUND OF THE INVENTION

The present invention relates to ultrasonic motors and processes for designing ultrasonic motor;.

With reference to FIG. 9, a standing wave type, or a bolted Langevin type, is known as a conventional ultrasonic motor. The ultrasonic motor includes a stator 51 and a rotor 52. The stator 51 includes metal blocks 53, 54, piezoelectric elements 55, 56, electrode plates 57, 58, 59, and a bolt (not shown). The metal blocks 53, 54, the piezoelectric elements 55, 56, the electrode plates 57, 58, 59 are stacked in a manner shown in FIG. 9. The ultrasonic motor thus has a substantially pillar-like shape. The bolt axially extends through the metal blocks 53, 54 to securely fasten the metal blocks 53, 54, the piezoelectric elements 55, 56, and the electrode plates 57, 58, 59 together.

A plurality of slits 54a is formed in a lower outer circumferential portion of the stator 51, or the outer circumference of the metal block 54, which is located at a lower position with respect to the metal block 53. The slits 54a generate torsional oscillation in accordance with axial oscillation.

The rotor 52 has a substantially cylindrical shape. A pressing holding mechanism (not shown) maintains the rotor 52 in a state pressed against the upper side of the stator 51, or the upper side of the metal, block 53, while allowing the rotor 52 to rotate in this state.

A plurality of slits 52a is formed in the outer circumference of the rotor 52 to generate torsional oscillation in accordance with axial oscillation.

When a high frequency voltage at a first resonance frequency f1 of the stator 51, referring to FIG. 10, is supplied to the ultrasonic motor, the piezoelectric elements 55, 56 generate axial oscillation. This causes the slits 54a of the metal block 54 to generate torsional oscillation. In this state, oscillation of the upper side of the metal block 53, or the stator 51, corresponds to coupling oscillation C3 that is generated by coupling large torsional oscillation C1 with axial oscillation C2, with reference to FIGS. 11(a) and 11(b). Thus, the buoyancy produced by the axial oscillation C2 of the stator 51 and the driving force generated by the torsional oscillation C1 of the stator 51 act to rotate the rotor 52 in a first direction in accordance with first characteristics. This rotation mode, in which the large torsional oscillation C1 is generated in the stator 51 to rotate the rotor 52 mainly by the torsional oscillation C1, is referred to as “a stator main mode”.

When a high frequency voltage at a second resonance frequency f2 of the stator 51, referring to FIG. 10, is supplied to the electrode plates 57 to 59, the piezoelectric elements 55, 56 generate axial oscillation. This causes the slits 54a of the metal block 54 to produce torsional oscillation. In this state, oscillation of the stator 51 (the upper side of the metal block 53) corresponds to coupling oscillation C6 that is generated by coupling small torsional oscillation C4, which is produced in a direction opposed to that of the torsional oscillation C1, with axial oscillation C5, with reference to FIGS. 12(a) and 12(b). The resonance frequency of the rotor 52 corresponds to the second resonance frequency f2.

The rotor 52 resonates in accordance with the axial oscillation C5 (the coupling oscillation C6) such that the slits 52a generate large torsional oscillation. This acts to rotate the rotor 52 in a second direction opposed to the first direction (a direction opposed to that of the stator main mode). Thus, the buoyancy produced by the axial oscillation C5 of the stator 51, the driving force generated by the torsional oscillation C4 of the stator 51, and the torsional oscillation of the rotor 52 act to rotate the rotor 52 in the second direction in accordance with second characteristics.

This rotation mode, in which the large torsional oscillation is generated in the rotor 52 to rotate the rotor 52 mainly by the torsional oscillation, is referred to as “a rotor main mode”. FIGS. 11(a), 11(b), 12(a), and 12(b) are views explaining the forms defined by the stator 51 during the oscillation, as determined by Finite Element Method (FEM).

However, the oscillations at the first and second resonance frequencies f1, f2 may not be efficiently produced in an equilibrated manner, depending on the structure and shape of the stator 51. That is, the rotation of the rotor in the first direction and the rotation of the rotor in the second direction, which is opposed to the first direction, may not be efficiently obtained in an equilibrated manner.

In other words, to efficiently produce the oscillations at the first and second resonance frequencies f1, f2 in an equilibrated manner, the stator 51 needs to be accordingly designed. This makes it difficult to design the ultrasonic motor.

### SUMMARY OF THE INVENTION

Accordingly, it is an objective of the present invention to provide an ultrasonic motor in which oscillation at a first resonance frequency for rotating a rotor in accordance with first characteristics and oscillation at a second resonance frequency for rotating the rotor in accordance with second characteristics are efficiently obtained in an equilibrated manner, and a process for designing the ultrasonic motor.

To achieve the foregoing and other objectives and in accordance with the purpose of the present invention, the invention provides an ultrasonic motor that includes a stator. The stator includes a piezoelectric element, a plurality of metal blocks that hold the piezoelectric element, and a fastener that extends through the piezoelectric element and the metal blocks to fasten the piezoelectric element and the metal blocks together. The ultrasonic motor also includes a rotor, which is pressed against one side of the stator in a contact state. The rotor is rotated in a first direction by generating oscillation at a first resonance frequency in the stator. Further, the rotor is rotated in a second direction opposed to the first direction by generating oscillation at a second resonance frequency, which corresponds to the resonance frequency of the rotor, in the stator. The outer diameter of the fastener is within the range of from 30% to 55% of the outer diameter of the Stator.

A further perspective of the present invention is a process for designing an ultrasonic motor. The ultrasonic motor includes a stator, which includes a piezoelectric element, a plurality of metal blocks that hold the piezoelectric element, and a fastener. The fastener extends through the piezoelectric element and the metal blocks to fasten the piezoelectric element and the metal blocks together. The ultrasonic motor also includes a rotor, which is pressed against one side of the stator in a contact state. In this process for designing an ultrasonic motor, the rotor is rotated in a first direction by generating oscillation at a first resonance frequency in the stator. Further, the rotor is rotated in a second direction opposed to the first direction by generating oscillation at a second resonance frequency, which corresponds to the resonance frequency of the rotor, in the stator. The outer diameter of the fastener is set within the range of from 30% to 55% of the outer diameter of the stator.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objectives and advantages thereof, may best be understood by reference to the following description of the presently preferred embodiments together with the accompanying drawings in which:

FIG. 1 is a perspective view showing an ultrasonic motor of an embodiment of the present invention;

FIG. 2 is a cross-sectional view showing the ultrasonic motor of FIG. 1;

FIG. 3 is a cross-sectional view showing a portion of the ultrasonic motor of FIG. 1;

FIG. 4 is a graph showing characteristics of frequency with respect to oscillation speed regarding a stator of the ultrasonic motor of FIG. 1;

FIG. 5 is a table evaluating oscillation in relation to variation in a ratio of a stator diameter to a bolt diameter;

FIG. 6 is a graph showing characteristics of frequency with respect to oscillation speed regarding a stator of a test example;

FIG. 7 is a graph showing characteristics of frequency with respect to oscillation speed regarding a stator of another test example;

FIG. 8 is a graph showing characteristics of frequency difference with respect to rotation speed regarding the ultrasonic motor;

FIG. 9 is a side view showing a prior art ultrasonic motor;

FIGS. 10 is a graph showing characteristics of frequency with respect to impedance for explaining resonance frequencies;

FIGS. 11(a) and 11(b) are views explaining oscillation of the stator; and

FIGS. 12(a) and 12(b) are views explaining oscillation of the stator.

### DETAILED DESCRIPTION OF THE PREFERRED EMBODIMENTS

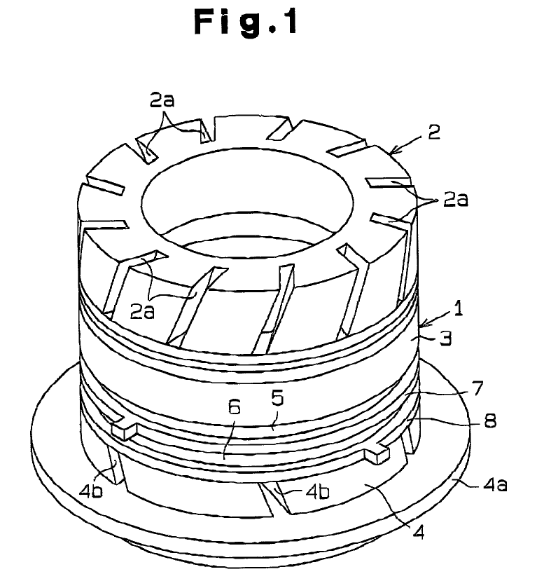

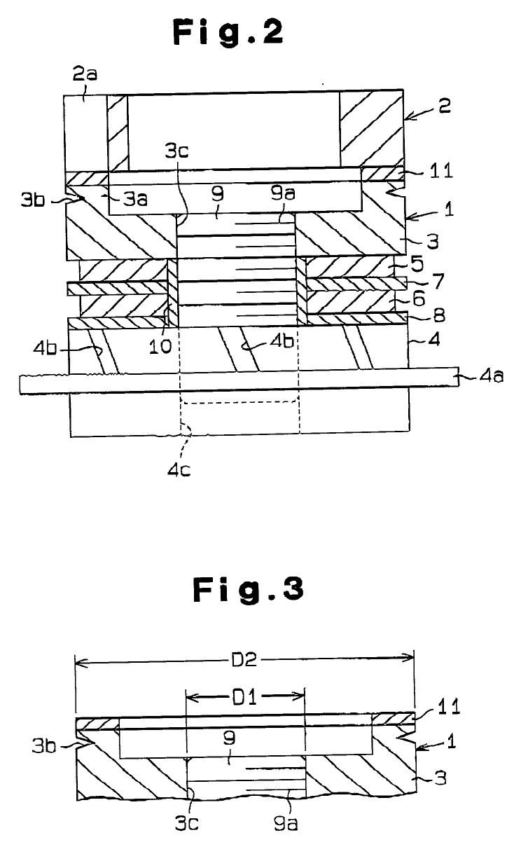

An ultrasonic motor of an embodiment of the present invention will now be described with reference to FIGS. 1 to 8. As shown in FIGS. 1 and 2, the ultrasonic motor includes a stator 1 that has an outer diameter and a rotor 2. The stator 1 has an upper metal block 3, a lower metal block 4, first (upper) and second (lower) piezoelectric elements 5, 6, first (upper) and second (lower) electrode plates 7, 8, a bolt 9 as a fastener having an outer diameter, and an insulating collar 10. The first and second piezoelectric elements 5, 6 are held by the upper and lower metal blocks 3, 4.

The upper and lower metal blocks 3, 4 are formed of conductive material, which is, in this embodiment, aluminum alloy. The upper metal block 3 has a substantially cylindrical shape. A horn section 3a is formed in an upper portion of the upper metal block 3 by enlarging the inner diameter of the upper portion of the metal block 3. The horn section 3a amplifies oscillation generated at an upper side of the upper metal block 3. A circumferential groove 3b is formed in the outer circumference of the horn section 3a. The circumferential groove 3b absorbs excessive strain that is generated at a position lower than the circumferential groove 3b, thus preventing the strain from being transmitted to the upper side of the upper metal block 3. A threaded portion 3c is formed in an inner circumferential portion of the upper metal block 3 that does not correspond to the horn section 3a. With reference to FIG. 3, the diameter D1 of the inner circumferential portion of the upper metal block 3 that does not correspond to the horn section 3a, or the diameter D1 of the threaded portion 3c, is 35% of the outer diameter D2 of the upper metal block 3. A thin friction material 11 is applied to the upper side of the upper metal block 3.

The lower metal block 4 also has a substantially cylindrical shape. The inner diameter of the lower metal block 4 is equal to the diameter D1 of the upper metal block 3, and the outer diameter of the lower metal block 4 is equal to the outer diameter D2 of the upper metal block 3. A fixing flange 4a projects radially outward from an axial intermediate portion of the lower metal block 4. A plurality of slits (recesses) 4b is formed in an outer circumferential portion of the lower metal block 4 at a position upward from the fixing flange 4a. The slits 4b generate torsional oscillation in accordance with axial oscillation. The slits 4b are aligned in a circumferential direction of the lower metal block 4, as slanted with respect to the axis of the metal block 4. A threaded portion 4c is formed in an inner circumferential portion of the lower metal block 4 (as indicated by broken lines in FIG. 2).

The first and second piezoelectric elements 5, 6 are each shaped as a disk with a through hole formed in the middle. The inner diameters of the first and second piezoelectric elements 5, 6 are larger than the diameter D1 of the upper metal block 3, or the inner diameter of the lower metal block 4.

The first and second electrode plates 7, 8 are each shaped as a disk with a through hole formed in the middle. The inner diameters of the first and second electrode plates 7, 8 are equal to the inner diameters of the first and second piezoelectric elements 5, 6.

The bolt 9 has a substantially pillar-like shape, and a threaded portion 9a is formed in the circumference of the bolt 9. The bolt 9 is engaged with the threaded portions 3c, 4c by the threaded portion 9a. With reference to FIG. 3, the diameter D1 of the bolt 9 is substantially equal to the diameter of the threaded portion 3c, or is 35% of the outer diameter D2 of the upper metal block 3.

The insulating collar 10 is formed of insulating resin in a cylindrical shape. The outer diameter of the insulating collar 10 is equal to the inner diameters of the first and second piezoelectric elements 5, 6 and those of the first and second electrode plates 7, 8. The inner diameter of the insulating collar 10 is equal to the diameter of the threaded portion 9a of the bolt 9. The bolt 9 is fitted to the insulating collar 10.

The first and second piezoelectric elements 5, 6 and the first and second electrode plates 7, 8 are held by the upper and lower metal blocks 3, 4. In this state, the bolt 9 axially extends through the upper and lower metal blocks 3, 4 to fasten the metal blocks 3, 4, the first and second piezoelectric elements 5, 6, and the first and second electrode plates 7, 8 together. More specifically, the lower metal block 4, tho second electrode plate 8, the second piezoelectric element 6, the first electrode plate 7, the first piezoelectric element 5, and the upper metal block 3 are stacked in this order. The threaded portion 9a of the bolt 9 is engaged with the threaded portions 3c, 4c of the upper and lower metal blocks 3, 4. The first and second piezoelectric elements 5, 6 are arranged such that the polarization directions of the first and second piezoelectric elements 5, 6 oppose each other in an upward and downward direction. The insulating collar 10 is located between the inner circumferences of the first and second piezoelectric elements 5, 6 and the first and second electrode plates 7, 8 and the circumference of the threaded portion 9a of the bolt 9. The first and second piezoelectric elements 5, 6 and the first and second electrode plates 7, 8 are thus electrically insulated from the bolt 9. Also, in this state, the second electrode plate 8 is electrically connected to the upper metal block 3 by the lower metal block 4 and the bolt 9.

The axial dimension of the stator 1 and the shape of each slit 4b are selected such that the difference Δf between a first resonance frequency f1 and a second resonance frequency f2 becomes smaller than or equal to 10 kHz. More specifically, in the stator 1 of this embodiment, the first resonance frequency f1 is approximately 66 kHz, and the second resonance frequency f2 is approximately 68 kHz (see FIG. 4). That is, the difference Δf between the first resonance frequency f1 and the second resonance frequency f2 is approximately 2 kHz (see FIG. 4).

The rotor 2 has a substantially cylindrical shape, and the outer diameter of the rotor 2 is substantially equal to the outer diameter D2 of the upper metal block 3, or the outer diameter of the lower metal block 4. A pressing holding mechanism (not shown) maintains the rotor 2 in a state pressed against the upper side of the stator 1, or the upper side of the friction material 11 applied to the lapper metal block 3, while allowing the rotor 2 to rotate as sliding on the upper side of the stator 1. A plurality of slits (recesses) 2a is formed in the outer circumference of the rotor 2 and is aligned in a circumferential direction of the rotor 2. The slits 2a generate torsional oscillation in accordance with axial oscillation. The slits 2a are each slanted with respect to the axis of the rotor 2.

The resonance frequency of the rotor 2 corresponds to the second resonance frequency f2 (approximately 68 kHz). More specifically, in this embodiment, the second frequency f2 of the stator 1, in which the outer diameter D2 of the upper metal block 3 and the diameter D1 of the bolt 9 are preselected, is first calculated. Afterwards, the shape of the rotor 2, including the axial dimension of the rotor 2 and the shape of each slit 2a, is determined such that the resonance frequency of the rotor 2 corresponds to the second resonance frequency f2.

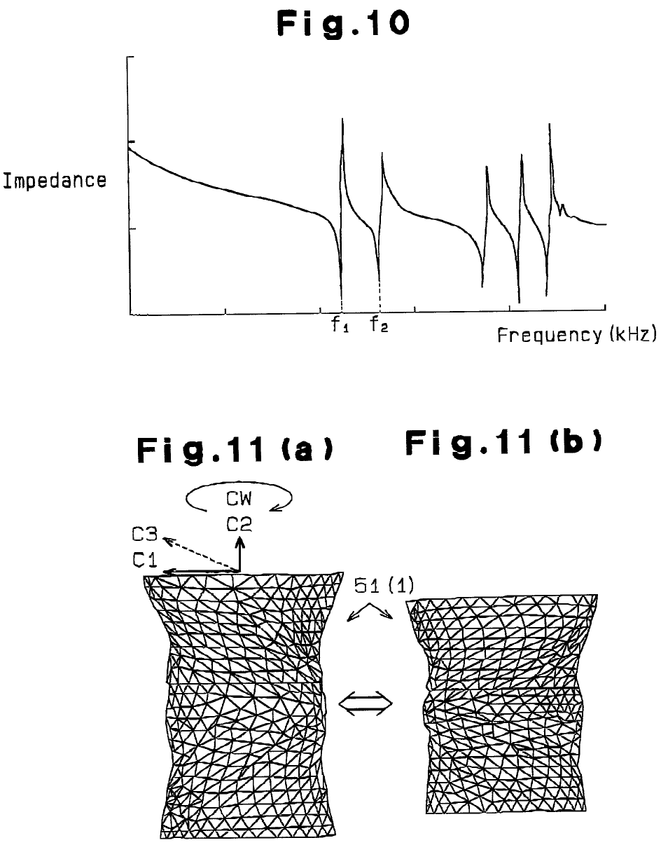

When a high frequency voltage at the first resonance frequency f1 (see FIG. 10) is introduced between the first and second electrode plates 7, 8 of the ultrasonic motor, the first and second piezoelectric elements 5, 6 generate axial oscillation. This causes the slits 4b of the stator 1 to produce torsional oscillation. In this state, oscillation of the upper side of the stator 1, or the upper side of the friction material 11 applied to the upper metal block 3, corresponds to the coupling oscillation C3 of FIGS. 11(a) and 11(b), which is generated by coupling the large oscillation C1 and the axial oscillation C2. Thus, the buoyancy generated by the axial oscillation C2 of the stator 1 and the driving force generated by the torsional oscillation C3 of the stator 1 act to rotate the rotor 2 in the first direction in accordance with the first characteristics (the stator main mode). The rotation characteristics of the rotor 2 include torque and speed, in addition to the rotational direction.

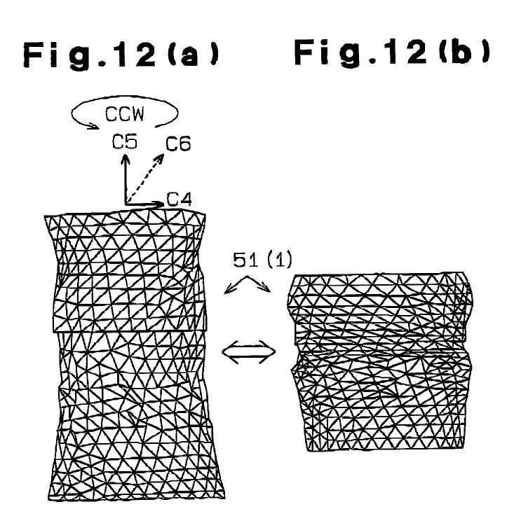

When a high frequency voltage at the second resonance frequency f2 (see FIG. 10) is introduced between the first and second electrode plates 7, 8 of the ultrasonic motor, the first and second piezoelectric elements 5, 6 generate axial oscillation. This causes the slits 4b of the stator 1 to produce torsional oscillation. In this state, oscillation of the upper side of the stator 1, or the upper side of the friction material 11 of the upper metal block 3, corresponds to the coupling oscillation C6 of FIGS. 12(a) and 12(b). The coupling oscillation C6 is generated by coupling the small oscillation C4, which is produced in a direction opposed to that of the torsional oscillation C1, and the axial oscillation C5. Since the resonance frequency of the rotor 2 corresponds to the second resonance frequency f2, the rotor 2 resonates in accordance with the axial oscillation C5 (the coupling oscillation C6), such that the slits 2a generate large torsional oscillation. This oscillation acts to rotate the rotor 2 in a direction opposed to the first direction of the stator main mode, or the second direction. Thus, the buoyancy generated by the axial oscillation C5 of the stator 1, the driving force generated by the torsional oscillation C4 of the stator 1, and the torsional oscillation of the rotor 2 act to rotate the rotor 2 in the second direction in accordance with the second characteristics (the rotor main mode).

FIG. 4 shows the results from a test regarding characteristics of frequency f with respect to oscillation speed v of the ultrasonic motor (the stator 1), in which the diameter D1 of the bolt 9 was 35% of the outer diameter D2 of the stator 1 (D1/D2=0.35). The oscillation speed v was substantially proportional to the movement amount, or the amplitude, of the stator 1. In FIG. 4, the solid line indicates radial oscillation speed Vr of the upper side of the stator 1, the double-dotted line indicates torsional oscillation speed vθ, and the chain line indicates axial oscillation speed Vz. The radial oscillation refers to oscillation in a direction to move the upper side of the stator 1 to a radially offset position, when the stator 1 is fixed by the flange 4a in a cantilever manner. That is, the radial oscillation is undesired for rotating the rotor 2. Thus, the lower the radial oscillation speed Vr becomes, the greater tho efficiency of the ultrasonic motor becomes.

As indicated by FIG. 4, the torsional oscillation speed Vθ and the axial oscillation speed VZ became relatively large at the first resonance frequency f1 (approximately 66 kHz) and the second resonance frequency f2 (approximately 68 kHz) in an equilibrated manner. That is, the torsional oscillation and the axial oscillation were efficiently produced at the first and second resonance frequencies f1, f2 in an equilibrated manner. Further, at the first and second resonance frequencies f1, f2, the radial oscillation speed Vr was relatively small, indicating that the undesired radial oscillation was suppressed. Particularly, at the first resonance frequency f1 (approximately 66 kHz), the torsional oscillation speed Vθ (corresponding to the torsional oscillation C1 in the stator main mode) became relatively large.

Accordingly, the rotation of the rotor 2 in the first direction (in accordance with the first characteristics) and the rotation of the rotor 2 in the second direction (in accordance with the second characteristics) were efficiently obtained in an equilibrated manner.

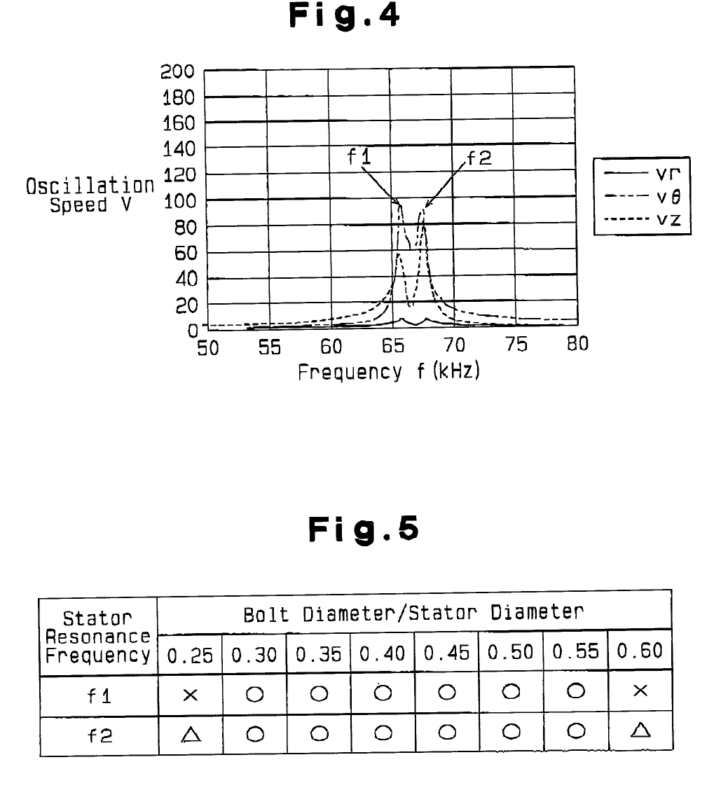

FIGS. 5, 6, and 7 each show the results from a test regarding the characteristics of the frequency f with respect to the oscillation speed V of the ultrasonic motor (the stator 1), in which the ratio of the diameter D1 of the bolt 9 to the outer diameter D2 of the stator 1 (D1/D2) was varied. FIG. 5 is a table that shows the results from a triple-scale evaluation test regarding oscillations at the first and second resonance frequencies f1, f2 in relation to the variation of the ratio D1/D2. In FIG. 5, each circle indicates that the rotor 2 was efficiently rotated, each triangle indicates that the rotor 2 was rotated but not efficiently, and each cross indicates that the rotor 2 was not rotated at all.

In the evaluation test, when the diameter D1 of the bolt 9 was 30, 40, 45, 50, or 55% of the outer diameter D2 of the stator 1 (D1/D2=0-30, 0-40, 0-45, 0-50, or 0-55), the characteristics of the frequency f with respect to the oscillation speed V of the ultrasonic motor (the stator 1) were similar to those of FIG. 4 (D1/D2=0.35). That is, the rotation of the rotor 2 in the first direction in accordance with the first characteristics and the rotation of the rotor 2 in the second direction in accordance with the second characteristics were efficiently obtained in an equilibrated manner. Accordingly, the corresponding test results, or the evaluations regarding the oscillation of the stator 1 with each of the aforementioned ratios D1/D2 at the first and second resonance frequencies f1, f2, are indicated by circles in FIG. 5.

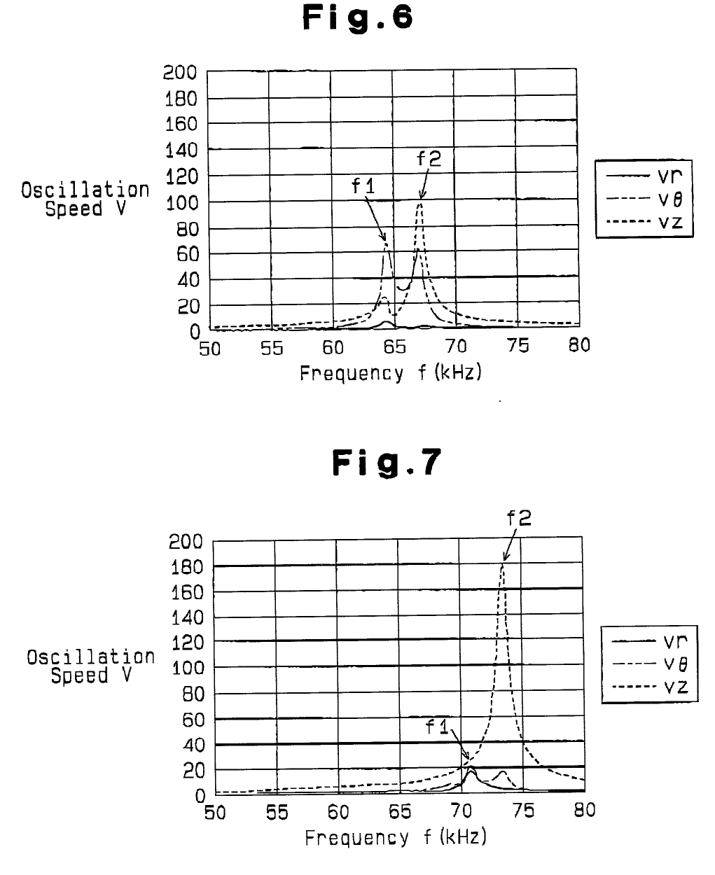

FIG. 6 shows the results from a test regarding the characteristics of the frequency f with respect to the oscillation speed V of the ultrasonic motor (the stator 1), in which the diameter D1 of the bolt 9 was 25% of the outer diameter D2 of the stator 1 (D1/D2−0.25). As indicated by FIG. 6, particularly at the first resonance frequency f1 (approximately 64 kHz), the torsional oscillation speed Vθ (corresponding to the torsional oscillation C1 in the stator main mode) became relatively small. Also, at the first resonance frequency f1, the axial oscillation speed VZ (corresponding to the axial oscillation C2 in the stator main mode) became significantly small. Accordingly, in this test, buoyancy and driving force for rotating the rotor 2 were insufficient, and the rotor 2 was incapable of rotating in the first direction. As a result, the corresponding test result, or the evaluation regarding the oscillation of the stator 1 in this test: (D1/D2=0.25) at the first frequency f1, is indicated by a cross in FIG. 5.

FIG. 7 shows the results from a test regarding the characteristics of the frequency f with respect to the oscillation speed V of the ultrasonic motor (the stator 1), in which the diameter D1 of the bolt 9 was 60% of the outer diameter D2 of the stator 1 (D1/D2=0.60). As indicated by FIG. 7, particularly at the first resonance frequency f1 (approximately 71 kHz), the torsional oscillation speed Vθ (corresponding to the torsional oscillation C1 in the stator main mode) became significantly small. Also, at the first resonance frequency f1, the axial oscillation speed VZ (corresponding to the axial oscillation C2 in the stator main mode) became significantly small. Accordingly, in this test, buoyancy and driving force for rotating the rotor 2 were insufficient, and the rotor 2 was incapable of rotating in the first direction. As a result, the corresponding test result, or the evaluation regarding the oscillation of the stator 1 in this test (D1/D2=0.60) at the first frequency f1, is indicated by a cross in FIG. 5.

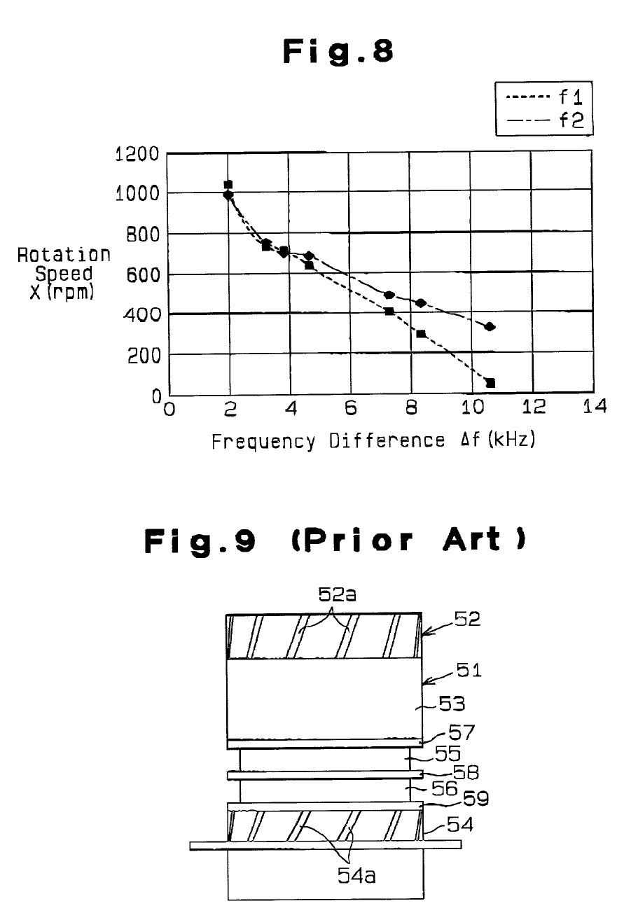

FIG. 8 shows the results from a test regarding characteristics of frequency difference Δf with respect to rotational speed X of the ultrasonic motor (the stator 1), in which the difference Δf between the first and second resonance frequencies f1, f2 was varied. In FIG. 8, the chain line indicates the rotational speed X at the first resonance frequency f1, and the single-dotted line indicates the rotational speed X at the second resonance frequency f2. In the test of FIG. 8, the shape of the stator 1, including the axial dimension of the stator 1 and the shape of each slit 4b, was changed to alter the frequency difference Δf. The shape of the rotor 2, including the axial dimension of the rotor 2 and the shape of each slit 2a, was also changed in accordance with the changes in the shape of the stator 1, such that the resonance frequency of the rotor 2 corresponded to the second resonance frequency f2.

As is clear from FIG. 8, when the frequency difference Δf between the first resonance frequency f1 (approximately 66 kHz) and the second resonance frequency f2 (approximately 68 kHz) was approximately 2 kHz, as in the illustrated embodiment, the rotational speed X of the rotor 2 in the first or second direction (in accordance with the first or second characteristics) was approximately 1000 rpm. In other words, when the frequency difference Δf was approximately 2 kHz, the torsional oscillation and the axial oscillation were efficiently generated at the first resonance frequency f1 (approximately 66 kHz) and the second resonance frequency f2 (approximately 68 kHz) in an equilibrated manner. That is, the rotation of the rotor 2 in the first direction in accordance with the first characteristics and the rotation of the rotor 2 in the second direction in accordance with the second characteristics were efficiently obtained in an equilibrated manner.

Further, as indicated by FIG. 8, as long as the frequency difference Δf between the first and second resonance frequencies f1, f2 was smaller than or equal to 10 kHz, the rotational speed X of the rotor 2 in the first or second direction remained approximately 100 rpm or higher. In other words, as long as the frequency difference Δf was smaller than or equal to 10 kHz, the torsional oscillation and the axial oscillation were efficiently produced at the first and second resonance frequencies f1, f2 in an equilibrated manner. That is, the rotation of the rotor 2 in the first direction (in accordance with the first characteristics) and the rotation of the rotor 2 in the second direction (in accordance with the second characteristics) were efficiently obtained in an equilibrated manner.

Also, as is clear from FIG. 8, when the frequency difference Δf between the first and second resonance frequencies f1, f2 was larger than 10 kHz, the rotational speed X of the rotor 2 in the first direction (in accordance with the first characteristics) was lower than about 100 rpm. In other words, when the frequency difference Δf was greater than 10 kHz, the torsional oscillation and the axial oscillation were not efficiently produced at the first and second resonance frequencies f1, f2 in an equilibrated manner. That is, the rotation of the rotor 2 in the first direction (in accordance with the first characteristics) and the rotation of the rotor 2 in the second direction (in accordance with the second characteristics) were not efficiently obtained in an equilibrated manner. Further, if the frequency difference Δf between the first and second resonance frequencies f1, f2 was excessively small, the rotor 2 became hard to control (for example, the rotational direction of the rotor 2 became hard to switch).

The advantageous effects of the illustrated embodiment are as follows.

(1) As described, in the illustrated embodiment, the diameter D1 of the bolt 9 is 35% of the outer diameter D2 of the upper metal block 3 of the stator 1 (D1/D2=0.35). Thus, the oscillation at the first resonance frequency f1 (approximately 66 kHz) and the oscillation at the second resonance frequency f2 (approximately 68 kHz) are efficiently produced in an equilibrated manner. In other words, the rotation of the rotor 2 in the first direction in accordance with the first characteristics and the rotation of the rotor 2 in the second direction in accordance with the second characteristics are efficiently obtained in an equilibrated manner. This reduces power consumption and minimizes a control unit for introducing a high frequency voltage between the first and second electrode plates 7, 8.

(2) Since the frequency difference Δf between the first and second resonance frequencies f1, f2 of the stator 1 is approximately 2 kHz, the oscillation at the first resonance frequency (approximately 66 kHz) and the oscillation at the second resonance frequency (approximately 68 kHz) are efficiently produced in an equilibrated manner. Thus, the rotation of the rotor 2 in the first direction (in accordance with the first characteristics) and the rotation of the rotor 2 in the second direction (in accordance with the second characteristics) are efficiently obtained in an equilibrated manner.

(3) In the stator 1 of the illustrated embodiment, the ratio of the diameter D1 of the bolt 9 to the outer diameter D2 of the outer metal block 3 is 35% (D1/D2=0.35). This makes it easy to design the ultrasonic motor (the stator 1) that efficiently produces the oscillation at the first resonance frequency (approximately 66 kHz) and the oscillation at the second resonance frequency (approximately 68 kHz) in an equilibrated manner.

(4) In the stator 1 of the illustrated embodiment, as described, the ratio of the diameter D1 of the bolt 9 to the outer diameter D2 of the outer metal block 3 is 35% (D1/D2=0.35). Further, the second resonance frequency f2 of the stator 1 is first computed, and the shape of the rotor 2 (including the axial dimension of the rotor 2 and the shape of each slit 2a) is then determined such that the resonance frequency of the rotor 2 corresponds to the second resonance frequency f2. This also makes it easy to design the stator 1.

It should be apparent to those skilled in the art that the present invention may be embodied in many other specific forms without departing from the spirit or scope of the invention. Particularly, it should be understood that the invention may be embodied in the following forms.

In the stator of the illustrated embodiment, the ratio of the diameter D1 of the bolt 9 to the outer diameter D2 of the upper metal block 3 is 35% (D1/D2=0.35). However, the ratio D1/D2 may be changed within a range of 30% to 55% (D1/D2=0.30-0.55), as necessary. In this case, the diameter D1 of the bolt 9 and the diameters of the threaded portions 3c, 4c of the upper and lower metal blocks 3, 4 must also be changed. This structure also enables the oscillation at the first resonance frequency f1 and the oscillation at the second resonance frequency f2 to be efficiently produced in an equilibrated manner. Accordingly, the rotation to the rotor 2 in the first direction in accordance with the first characteristics and the rotation of the rotor 2 in the second direction in accordance with the second characteristics are efficiently obtained in an equilibrated manner.

In the stator 1 of the illustrated embodiment, the difference Δf between the first resonance frequency f1 and the second resonance frequency f2 is approximately 2 kHz. However, the frequency difference Δf may be changed within a range of 2 kHz to 10 kHz, as necessary. In this case, the shape of the rotor 2 must be changed in accordance with the changes in the stator 1, such that the resonance frequency of the rotor 2 corresponds to the second resonance frequency f2. This structure also enables the oscillation at the first resonance frequency f1 and the oscillation at the second resonance frequency f2 to be efficiently produced in an equilibrated manner. Accordingly, the rotation of the rotor 2 in the first direction and the rotation of the rotor 2 in the second direction are efficiently obtained in an equilibrated manner at the rotational speed x of, for example, at least approximately 100 rpm.

Further, if the difference Δf between the first resonance frequency f1 and the second resonance frequency f2 is, for example, approximately 2-5 kHz, the rotation of the rotor 2 in the first direction and the rotation of the rotor 2 in the second direction are efficiently obtained in an equilibrated manner at the substantially same rotational speeds X, or, for example, approximately 600 rpm or higher. Further, since the frequency difference Δf is not excessively small, the rotor 2 remains relatively easy to control, or, for example, the rotational, direction of the rotor 2 may be switched relatively easily.

In the illustrated embodiment, the threaded portions 3c, 4c are each formed in the inner circumference of the associated one of the upper and lower metal blocks 3, 4. The bolt 9 is engaged with the threaded portions 3c, 4c to fasten the upper and lower metal blocks 3, 4 together. However, the bolt 9 may be replaced by other fasteners. For example, a bolt with a head may be inserted in through holes formed in the upper and lower metal blocks 3, 4. A nut is then fastened to the distal end of the bolt, thus fastening the upper and lower metal blocks 3, 4 together by the head of the bolt and the nut. If this is the case, the diameter of the portion of the bolt other than the head is selected from a range of 30% to 55% of the outer diameter D2 of the stator 1 (the upper metal block 3) (D1/D2−0.30-0.55). This structure also enables the oscillation at the first resonance frequency f1 and the oscillation at the second resonance frequency f2 to be efficiently produced in an equilibrated manner.

In the illustrated embodiment, the slits (oscillation converting portions) 4b, 2a are formed in the lower metal block 4 and the rotor 2. The number of the slits 4b, 2a and the shape of each slit 4b, 2a may be changed as necessary, as long as torsional oscillation is generated in accordance with axial oscillation. In this case, the same effects as those of the illustrated embodiment are obtained.

The ultrasonic motor of the illustrated embodiment has the two metal blocks (the upper and lower metal blocks 3, 4) However, the number of the metal blocks may be changed. For example, the lower metal block 4 may be axially divided. That is, the portion of the lower metal block 4 corresponding to the slits 4b and the remainder of the lower metal block 4 may be formed independently from each other. In this case, the same effects as those of the illustrated embodiment are also obtained.

The stator 1 of the illustrated embodiment includes the two piezoelectric elements (the first and second piezoelectric elements 5, 6). However, the number of the piezoelectric elements may be changed, as necessary. For example, the stator 1 may include a single piezoelectric element or three piezoelectric elements. In these cases, the same effects as those of the illustrated embodiment are also obtained.

The stator 1 of the illustrated embodiment includes the two electrode plates (the first and second electrode plates 7, 8) . However, the number of the electrode plates may be changed, as necessary. For example, the electrode plates may be omitted from the stator 1 (in this case, the metal blocks function as electrode plates). Alternatively, the stator 1 may include three electrode plates. Also in these cases, the same effects as those of the illustrated embodiment are obtained.

The present examples and embodiments are to be considered as illustrative and not restrictive and the invention is not to be limited to the details given herein, but may be modified within the scope and equivalence of the appended claims.

1. An ultrasonic motor comprising:
a stator having an outer diameter, wherein said stator includes:
a piezoelectric element;
a plurality of metal blocks, wherein the piezoelectric element is held by the metal blocks; and
a fastener having an outer diameter, wherein said fastener extends through the piezoelectric element and the metal blocks to fasten the piezoelectric element and the metal blocks together; and
a rotor, which is pressed against one side of the stator in a contact state;
wherein the rotor is rotated in a first direction by generating oscillation at a first resonance frequency in the stator, and the rotor is rotated in a second direction opposed to the first direction by generating oscillation at a second resonance frequency, which corresponds to the resonance frequency of the rotor, in the stator; and
wherein the outer diameter of the fastener is within the range of from 30% to 55% of the outer diameter of the stator.

2. The ultrasonic motor according to claim 1, wherein the difference between the first resonance frequency and the second resonance frequency is within the range of from 2 kHz to 10 kHz.

3. The ultrasonic motor according to claim 2, wherein the difference between the first resonance frequency and the second resonance frequency is within the range of from 2 kHz to 5 kHz.

4. The ultrasonic motor according to claim 1, wherein each of the metal blocks has an outer diameter, and wherein the outer diameter of the stator is equal to the outer diameter of each of the metal blocks.

5. The ultrasonic motor according to claim 1, wherein the fastener is a bolt.

6. An ultrasonic motor, comprising:
a stator having an outer diameter, wherein said stator includes:
an upper piezoelectric element and a lower piezoelectric element;
an upper electrode plate and a lower electrode plate;
an upper metal block and a lower metal block; and a fastener having an outer diameter, wherein said fastener extends through the lower metal block, the lower electrode plate, the lower piezoelectric element, the upper electrode plate, the upper piezoelectric element, and the upper metal block that are stacked in the order, such that the piezoelectric elements, the electrode plates, and the metal plates are fastened together; and a rotor, which is pressed against one side of the stator in a contact state;
wherein a high frequency voltage is supplied to the electrode plates to enable the piezoelectric elements to generate oscillation at a first resonance frequency in the stator, such that the rotor is rotated in a first direction, and to enable the piezoelectric elements to generate oscillation at a second resonance frequency, which corresponds to the resonance frequency of the rotor, in the stator, such that the rotor is rotated in a second direction opposed to the first direction; and
wherein the outer diameter of the fastener is within the range of from 30% to 55% of the outer diameter of the stator.

7. The ultrasonic motor according to claim 6, wherein the difference between the first resonance frequency and the second resonance frequency is within the range of from 2 kHz to 10 kHz.

8. The ultrasonic motor according to claim 6, wherein the difference between the first resonance frequency and the second resonance frequency is within the range of from 2 kHz to 5 kHz.

9. The ultrasonic motor according to claim 6, wherein each of the metal blocks has an outer diameter, and wherein the outer diameter of the stator is equal to the outer diameter of each of the metal blocks.,

10. The ultrasonic motor according to claim 6, wherein an insulating member is located between the stator and the fastener.

11. An ultrasonic motor, comprising:
a stator having an outer diameter, wherein said stator includes:
a piezoelectric element;
a plurality of metal blocks, wherein the piezoelectric element is held by the metal blocks; aid
a fastener having an outer diameter, wherein said fastener extends through the piezoelectric element and the metal blocks to fasten the piezoelectric element and the metal blocks together; and
a rotor, which is pressed against one side of the stator in a contact state;
wherein the rotor is rotated in accordance with first characteristics by generating oscillation at a first resonance frequency in the stator, and the rotor is rotated in accordance with second characteristics by generating oscillation at a second resonance frequency, which corresponds to the resonance frequency of the rotor, in the stator; and
wherein the outer diameter of the fastener is within the range of from 30% to 55% of the outer diameter of the stator.

12. A stator of an ultrasonic motor that oscillates to rotate a rotor, wherein said stator has an outer diameter, said stator comprising:
a piezoelectric element;
a plurality of metal blocks, wherein the piezoelectric element is held by the metal blocks; and
a fastener having an outer diameter, wherein said fastener extends through the piezoelectric element and the metal blocks to fasten the piezoelectric element and the metal blocks together;
wherein the rotor is rotated in a first direction by generating oscillation at a first resonance frequency in the stator, and the rotor is rotated in a second direction opposed to the first direction by generating oscillation at a second resonance frequency, which corresponds to the resonance frequency of the rotor, in the stator; and
wherein the outer diameter of the fastener is within the range of from 30% to 55% of the outer diameter of the stator.

13. A process for designing an ultrasonic motor, wherein the ultrasonic motor includes:
a stator, which includes a piezoelectric element, a plurality of metal blocks, wherein the piezoelectric element is held by the metal blocks, and a fastener having an outer diameter, wherein said fastener extends through the piezoelectric element and the metal blocks to fasten the piezoelectric element and the metal blocks together; and
a rotor, which is pressed against one side of the stator in a contact state;
wherein the rotor is rotated in a first direction by generating oscillation at a first resonance frequency in the stator, and the rotor is rotated in a second direction opposed to the first direction by generating oscillation at a second resonance frequency, which corresponds to the resonance frequency of the rotor, in the stator, the process comprising:
setting the outer diameter of the fastener within the range of from 30% to 55% of the outer diameter of the stator.

14. The process according to claim 13, wherein the outer diameter of the fastener and the outer diameter of the stator are first determined, followed by computation of the second resonance frequency of the stator in accordance with the determinations of the outer diameter of the fastener and the outer diameter of the stator, and the shape of the rotor is determined such that the resonance frequency of the rotor substantially corresponds to the second resonance frequency.

15. The process according to claim 13, wherein the difference between the first resonance frequency and the second resonance frequency within the range of from 2 kHz to 10 kHz.

16. A process for designing an ultrasonic motor, wherein the ultrasonic motor includes:
a stator, which includes a piezoelectric element, a plurality of metal blocks, wherein the piezoelectric element in held by the metal blocks, and a fastener having an outer diameter, wherein said fastener extends through the piezoelectric element and the metal blocks to fasten the piezoelectric element and the metal blocks together; and
a rotor, which is pressed against one side of the stator in a contact state,
wherein the rotor is rotated in accordance with first characteristics by generating oscillation at a first resonance frequency in the stator, and the rotor is rotated in accordance with second characteristics by generating oscillation at a second resonance frequency, which corresponds to the resonance frequency of the rotor, in the stator, the process comprising:
setting the outer diameter of the fastener within the range of from 30% to 55% of the outer diameter of the stator.
